(19) United States
(12) Patent Application Publication
(10) Pub. No.: US 2006/0224508 A1
(43) Pub. Date: Oct. 5, 2006

(54) Online debit cardless debit transaction system and method

(76) Inventor: Guy David Fietz, Calgary (CA)

Correspondence Address: BORDEN LADNER GERVAIS LLP, WORLD EXCHANGE PLAZA, 100 QUEEN STREET SUITE 1100, OTTAWA, ON, K1P 1J9, CA

(21) Appl. No.: 11/392,837

(22) Filed: Mar. 30, 2006

Related U.S. Application Data
(60) Provisional application No. 60/668,110, filed on Apr. 5, 2005.

(51) Int. Cl. G06Q 40/00

(52) U.S. Cl. 705/40

(57) ABSTRACT

Discloses a payment transfer system used to transfer funds from a payer to a payee using an online payment processor gateway. The payment processor gateway is accessible by a payer over the internet from a merchant web site or by telephone contact using mobile SMS messaging or mobile, POTS or VoIP interactive voice response. The payer is authenticated to use the system by a challenge response process. The challenge response process may include a user identifier such as a card number and related password or PIN or the challenge response may include a scanned biometric parameter such as a fingerprint or retinal scan.

### CROSS REFERENCE TO RELATED APPLICATIONS

This application claims the benefit of priority of U.S. Provisional Patent Application No. 60/668,110, filed Apr. 5, 2005, which is incorporated herein by reference.

### FIELD OF THE INVENTION

A system and method for conducting a real time purchase of a service or good—tangible and intangible product.

### BACKGROUND OF THE INVENTION

Recently the Internet has become increasingly popular with particular use of the World Wide Web communication capability which allows information to be organized, searched and presented over the Internet using hypertext transfer protocol. Using the Internet World Wide Web enables a user to submit a query for information and be linked electronically to Internet locations that contain the information of interest. This has resulted in a proliferation of Internet users with numerous services provided over the Internet. One of the more popular such services is ecommerce and electronic banking. Ecommerce allows a user to purchase goods or services from vendors on the Internet and electronic banking allows bank customers to access their account information and execute banking transactions, such as the transfer of funds from a savings to a checking account, by simply linking to a bank server using the Internet to access account information and communicate transfer instructions.

Electronic banking has advanced from this basic consumer-to-bank communication to a consumer being able to electronically pay bills and make other payment types and fund transfers to others by communicating instructions, via the Internet, to the financial institution that the user maintains a deposit account with or is able to credit funds to a preregistered vendor or supplier. The payments are then made to the payee vendor or supplier by the financial institution. Because of geographic or legal or other shortcomings, a service provider possibly distinct from the financial institution may be used to supply payment to the payee using the service provider as a payment intermediary. The term “payment” includes payment of bills as well as other transfers or payments that are not based upon bills. Funds from the payer's deposit or credit account, i.e. the payer's payment account, are debited by the service provider to cover the payment. The payment by the service provider to the designated payee is made in a variety of ways such as by electronic transfer of funds from the payer's banking account to the payee's banking account or by electronic transfer funds from a service provider's banking account to the payee's banking account, or there may be a paper draft or check drawn on the service provider's banking account and mailed to the payee, or there may be a wire transfer to the payee's account from either the service provider's banking account or the payer's banking account.

If the funds transferred to the payee are drawn from the service providers banking account, funds from the payer's banking account are electronically or otherwise transferred to the service provider's banking account to cover the payment. Further, if the payment is to be made from funds in the service provider's banking account, the payment will preferably be consolidated with payments being made to the same payee on behalf of other payers. In this manner electronic payment systems eliminate the need for a payer to write or print paper checks and then mail them to the payee, making it easier and more efficient to make payments. For example, payees receiving consolidated payments no longer have to deal with checks from each payee and therefore can process payments more efficiently. The making of payments by the electronic or wire transfer of funds provides even further efficiencies in payment processing by payees and can significantly reduce the cost of processing payments for both the payer and the payee.

Generally, a payer must be a registered user of conventional electronic payment systems. Registration protects a provider of electronic payment services from credit risk. To register a user, the service provider typically obtains and validates information relating to the user to verify the user's identity and processes the obtained information to determine if the service provider will accept the credit risk of making payments on the user's behalf. Registration may be a somewhat simplified process whereby a user submits, on-line, information identifying his or her bank account and financial institution and his or her identity. This information typically includes a name, address, phone number, and other identifying information, or some variation thereof. Other systems require that the potential user supply a voided check from the user's checking account.

Even with the simplified on-line information submittal, the payer is generally not able to direct payments immediately after submitting registration information. Typically the user must wait for the service provider to validate and process the registration information and to receive a confirmation that the registration process is complete.

As paying for goods and services online over the internet becomes more of an everyday event, users are increasingly subjected to fraud and identity theft when transferring credit or debit card information over the internet. Fraudulent credit/debit card use from stolen identification or cards have caused the credit card companies to charge large fees to merchants and aggregators for these non-collectible transactions. For example, credit card companies holdback settlements and may in addition impose charge back fees. Moreover, the payment to the merchant is typically a batch process not in real time. As a result, reconciliation becomes difficult to maintain and balance as returns to the merchant are not 100%. As a result there is a need for a real time secure transfer of funds online for goods and services.

Various solutions have heretofore been proposed including US published patent application 20020087471 by Ganesan et al; US published patent application 20040019605 by Keown et al; US published patent application 20020077978 by O'Leary et al; US published patent application 20040139014 by Song et al; US published patent application 20040148252 by Flieshman and PCT published patent application publication number WO02059847 by Flieshman.

### SUMMARY OF THE INVENTION

In accordance with one aspect of the invention, a debit payment or process is completed over the telephone or internet without requiring a debit or credit card swipe or the need physically to present the card. The method provides a settlement mechanism for a purchase transaction to complete the purchase. A source of funds is obtained from any one of a variety of funds providers that the payer has an established relationship with and can include, by way of example, a debit card account with a bank or a credit card issued by a financial institution. The transaction settlement process provides payment to the merchant or presents a payment option to the merchant business in order to complete the purchase.

The settlement mechanism is a short step real time secure payment system for online transactions and operates without using a credit or debit card. In an internet based embodiment of the invention, a payment processor web server is accessible by the payer to interact with the payer and determine a course of action for the transaction. In one manner of interaction, the payment processor web server redirects the payer to the secure online banking website that the payer is a customer of and maintains an account with. The secure online baking website is the public web site maintained by the bank or Financial Institution (FI) that the payer customer uses and interacts with to access his or her account at the FI. Ideally the customer has established or registered for online account access with the FI to permit the customer to use the telephone/internet banking services offerings of the financial institution. In the event the payer is not yet registered, they register in real time and resume the remaining steps with the financial institution.

In one process arrangement where the consumer maintains a profile with the payment processor service, on arrival at the payment processor server, the user authenticates to the server by completing a challenge-response authentication process. One form of authentication process is performed by entering the user account number or client card number and the corresponding PIN or password to complete the authentication. Another form of authentication process employs a temporal password or PIN that changes over time, for example with each login or over a fixed time duration such as every few days, minutes or seconds. When a temporal password is used the customer has a synchronization device, such as an LCD card or keychain device that produces and displays at least a portion of the password or PIN. Another form of authentication process employs a biometric device to produce a password or PIN based on a user indicator that is unique to each particular person such as a fingerprint, retinal or iris scan. Once a user has been authenticated, they are then sent to the next page or step which has links to all participating Financial Institutions. The user is directed to the selected FI site and, based on successful authentication at the FI site, the user has the ability to then debit their account and credit the merchant or, alternately, credit the payment processor which would then in turn credit the merchant account. Fees could be removed and kept by the processor real time as part of the payment settlement process or fees could be later invoiced or billed or have an auto debit feature agreement with the merchant to debit the merchant account for fees due in the cycle. Cycle periods may vary. In either case the financial institution will send a settlement validation to the merchant either directly or through the payment processor to notify the merchant that the goods or services have been paid for. The merchant may then release the goods or services to complete the transaction. This transaction could also be agreed to by the consumer and the merchant under proper disclosure of terms and conditions to have a regular consumer debit occur on an agreed schedule i.e.: daily weekly, monthly, quarterly yearly etc. to credit the merchant for goods and or services rendered.

The payment processor or the merchant/payee must be registered with the FI's online banking systems as a payee or be assigned an online merchant account which may or may not coincide with their credit card account merchant to be able to accept deposits.

As this method of processes causes a real time online secure transfer of funds, bad debt is virtually eliminated along with fraud and identity theft as the completion of the transaction happens inside the financial institution's online banking secure website of that particular person. Users or licensees of the system of the invention include retailers, eTailers, service providers, banks and other corporations.

Payment or settlement of transactions using the system of the invention over the internet is facilitated from any merchant internet website providing the payee merchant is registered. The payer or consumer is able to access the system from a computer or a wireless PDA and the consumer is registered with the FI or payment processor. The invention permits a consumer to transact on the internet securely without entering their credit card or debit card expiry date or pin. This will eliminate or reduce the risk of identity theft and allow consumers to purchase goods and services online which do not allow or have credit or debit cards as a payment option. Merchants which may have a higher exposure to fraud may want to have this as the only option.
1. In one of its aspects the invention provides a payment transfer system for transferring funds from a payer to a payee, from an online payment processor gateway accessible from a merchant web site by the payer that has means for identifying a payer and designating a payer financial institution; means for specifying a source of funds and payment amount for a transfer of funds from the payer financial institution as well as means to transfer said payment amount from said source of funds to a gateway suspense account. The system further includes means for identifying a payee corresponding to the merchant web site; means for payee settlement of the payment amount from the gateway suspense account, and means to reconcile the gateway suspense account.
2. In another of its aspects, the invention provides a payment transfer method for transferring funds from a payer to a payee that includes the steps of i) providing a payment processor gateway accessible from a merchant web site; receiving an identification of a payer and a designation of a payer financial institution at the payment processor gateway; receiving a specification of a source of funds and payment amount for a transfer of funds from the payer financial institution to produce a settlement commitment. The steps further include transferring said payment amount from said source of funds to a gateway suspense account; identifying a payee corresponding to the merchant web site; providing payee settlement of the payment amount to the identified payee from the gateway suspense account corresponding to said settlement commitment; and reconciling the gateway suspense account.

In yet another of its aspects, the invention provides a system for generating a payment request for a recipient that includes means for accessing a first online banking service; means for providing payment request data to the first online banking service including a payment amount and an account for receiving a payment described by the payment request data and means for notifying the recipient of the payment request. Also included are means for specifying an account affiliated with the recipient to receive the payment amount of the payment request; means for approving receipt of the payment amount of the payment request on the specified account affiliated with the recipient; and means for effecting a transfer of funds in the amount of the payment amount of the payment request from the first online banking service to the account affiliated with the recipient for receiving the payment.

And in yet another of its aspects, the invention provides a payment transfer system for transferring funds from a payer to a payee where the payer transfers the funds in a first currency and the payee receives the funds in a second currency that includes an online payment processor gateway accessible by the payer from a merchant web site including means for identifying the payer and designating a payer source of funds and means for specifying a payment amount in the first currency for a transfer of funds in the first currency from said payer source of funds; means for receiving said payment amount in the first currency from said payer account and retaining said funds in the first currency in a payment processor suspense account and means for converting the payment amount in the first currency to a payment amount in said second currency. Also provides are means for identifying the payee and specifying a payee account to receive the funds of the payment amount of the second currency; means for debiting the funds in the second currency from the suspense account and crediting the funds in the second currency to the payee account; and means for reconciling the payment processor suspense account.

In yet another of its aspects, the invention provides a payment transfer method for transferring funds from a payer to a payee, where the payer transfers the funds in a first currency and the payee receives the funds in a second currency that includes the steps of accessing a banking service affiliated with the payer; designating a payee; specifying a payment amount in the first currency for a transfer of funds and a payer account from which to draw funds in the first currency and debiting said funds in the first currency from said payer account and crediting said funds in the first currency into a suspense account. The method further includes converting the payment amount in the first currency to a payment amount in the second currency; accessing a second online banking service affiliated with the payee and identifying the payee and a payee account to receive the funds of the payment amount of the second currency; and debiting the funds in the second currency from the suspense account and crediting the funds in the second currency to the payee account.

Embodiments of the invention will now be described with reference to the attached drawings.

### BRIEF DESCRIPTION OF THE DRAWINGS

FIG. 1 shows a network diagram of an embodiment of the invention.

FIG. 2 shows a functional block diagram of an embodiment of the invention.

### DETAILED DESCRIPTION OF THE INVENTION

In the following description, for purposes of explanation, numerous details are set forth in order to provide a thorough understanding of the present invention. However, it will be apparent to one skilled in the art that these specific details are not required in order to practice the present invention. In other instances, well-known electrical structures and circuits are shown in block diagram form in order not to obscure the present invention. For example, specific details are not provided as to whether the embodiments of the invention described herein are implemented as a software routine, hardware circuit, firmware, or a combination thereof.

Embodiments of the invention may be represented as a software product stored on a machine-readable medium (also referred to as a computer-readable medium, a processor-readable medium, or a computer usable medium having a computer readable program code embodied therein). the machine-readable medium may be any type of magnetic, optical, or electrical storage medium including a diskette, compact disk read only memory (CD-ROM), memory device (volatile or non-volatile), or similar storage mechanism. The machine-readable medium may contain various sets of instructions, code sequences, configuration information, or other data. Those of ordinary skill in the art will appreciate that other instructions and operations necessary to implement the described invention may also be stored on the machine-readable medium. Software running from the machine readable medium may interface with circuitry to perform the described tasks.

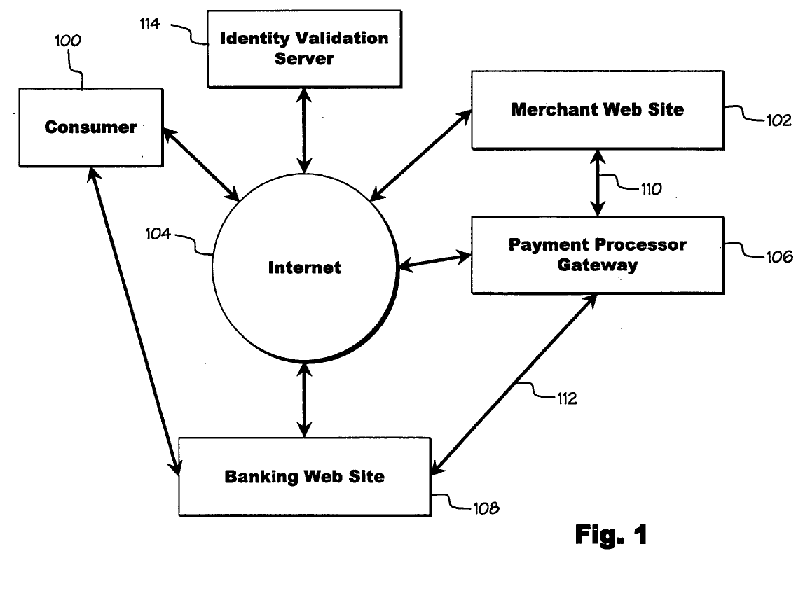

FIG. 1 shows a network diagram of an embodiment of the invention. A consumer uses a personal computer 100 running a network client, such as Internet Explorer (trademark) or Netscape Navigator (trademark), to visit a merchant web site 102 made available on the internet 104. When the consumer desires to make a purchase of the goods or services offered by the merchant from the web site, the user chooses the option of paying for the goods using a mutually agreeable payment processor service that operates a payment processor gateway 106. At the merchant web site, the user is provided with a payment option that provides for transaction settlement that directs the user to interact with the payment processor gateway 106. The payment processor gateway authenticates the user by completing a challenge-response authentication process. One form of authentication process is performed by the user entering an account number or client card number and the corresponding PIN or password to complete the authentication. Another form of authentication process employs a temporal password or PIN that changes over time, for example with each login or over a fixed time duration such as every few days, minutes or seconds. When a temporal password is used the customer has a synchronization device, such as an LCD card or keychain device that produces and displays at least a portion of the password or PIN. Another form of authentication process employs a biometric device to produce a password or PIN based on a user indicator that is unique to each particular person such as a fingerprint, retinal or iris scan.

Once authenticated the user is provided with the option to select a source of funds to settle the merchant transaction from a list of financial institutions that includes at least one financial institution that the consumer maintains accounts with, which can include accounts the user may hold at the payment processor service itself. Each financial institution that participates in the payment settlement services provided by the payment processor through the gateway 104 maintains a banking web site 108 that a consumer can access directly over the internet 104. When the consumer is directed to the payment processor gateway 106, the consumer selects the banking web site 108 that is desired to be used for payment of the goods or services selected from the merchant web site 102. When the consumer has selected the desired financial institution, the consumer is directed to the web site of that financial institution and the consumer logs onto the web site in the same fashion using the same validation mechanism familiar to the consumer when the banking web site is accessed directly. The consumer then selects the account that is to be used for a source of funds for payment of the pending web purchase transaction. The account can be a chequing, savings or credit card account, and the actual account selected by the consumer will depend on what accounts the consumer maintains with the financial institution and the accessibility of funds in the account for use in settlement of the pending merchant transaction. The consumer will identify the payer and the amount of funds that are to be drawn from the selected account. When the payment instructions have been accepted by the banking web site, the consumer will be provided with a transaction reference that uniquely identifies the payment acceptance. The payee will be the payment processor operating the payment processor gateway 106 or the merchant operating the merchant web site 102, depending on the selection made by the consumer taking into account the type of account that the consumer uses as a source of funds for settlement of the transaction, the location or jurisdiction of the merchant web site and the payment settlement rules of the financial institution operating the banking web site 108. The unique reference number obtained from the banking web site is used by the payment processor gateway 106 to guarantee funds to the merchant web site in settlement of the pending transaction. The payment processor gateway provides a settlement commitment 110 to the merchant web site to complete and settle the outstanding pending transaction.

Thus the payment processor web site provides a consolidation page where all financial institutions that are integrated into this ability have a presence on the selection pages at the payment processor gateway, for example on a banner or on bar or word or logo identifying the financial institution thus making that financial institution available for selection by the consumer when directed to the payment processor gateway 106.

When the consumer has completed interacting with the selected banking web site, validation of the source of funds selected by the consumer is recognized by the financial institution sending a unique transaction reference, which provides a receipt of confirmation of the transaction 112 back to the payment processor gateway and the funds are paid to the merchant vendor from a suspense account of the payment processor. Incoming payments from FI's to the payment processor are deposited into the suspense account to complete the funds transfer process.

The payment processor may aggregate merchant or vendor names on their payee list which can be added by the payee in the form of an easily identified name of the actual merchant or a code which may be alpha or numeric or alpha-numeric.

The consumer will choose the FI they belong to which will send them by clicking on the button or bar or scroll window to the entry page for online banking of that particular FI.

In another variation, the account generation could identify both the merchant and processor and consumer along with other information with alpha numeric coding or a combination of both. Or bill number or invoice number generation would be generated by the merchant or it's partner to quote later as the payee. Preferably this is generated uniquely for each transaction or generally for that individual/consumer which would identify him or her to the merchant or processor. This number may be used as a regular or one time use for the payee or merchant to be identified at the FI.

In another variation, a bill or invoice is sent from the merchant to the consumer directly though the processor real time bank site or, if a bill is generated, at the merchant site. The bill details and related information may follow the consumer once they have hit the “pay” button as they are redirected to the selected FI web site. For example, in one manner of operation, the information is set up to stay visible in a separate window so the consumer is able to populate the necessary fields in the other steps at the FI web site. The payment processor is able to pass the necessary identifying details from the bill or extract the necessary information to complete the payment, such as the merchant or payee name, payment amount and the payee account number or reference directing where the settlement amount is to be delivered.

The payment processor service will fit this process by providing account coding to accommodate and to differentiate the requirement for each of the various payee merchants. The payment processor may provide online terms and conditions agreements for sign up to become a registered merchant or payee where there is also offered downloadable buttons of bars to populate the payee website with to permit a payment option button or bar to appear to and be operated by visitors to that merchant's web site. This could be visible to the consumer. This could be real time as there is no credit extended to the FI, or most likely by the processor.

Payment confirmation or validation messages are sent from the payer's bank site servers to the payment processor's servers directly as indicated by 112. The confirmation or validation message is preferably sent as an encrypted message. In the preferred manner of operation, the payment confirmation or validation message is authenticated by an outside identity validation server 114 independent of the bank servers and payment processor servers. This provides for security as the identity validation server passes the message and logs it and may translate, decrypt or re encrypt the confirmation or validation message into another form for delivery to the payment processor. The payment processor receives the payment confirmation or validation message and keeps it in a confirmation database.

The payment confirmation or validation message may be received by the payment processor directly from the FI or indirectly from an outside identity validation server or joint messages from both the FI and the outside identity validation server 114. In turn, the payment processor sends the authorization or confirmation (validation) of payment message to the merchant as depicted by 110. The payment confirmation or validation message is alpha or numeric or alpha-numeric. The confirmation or validation message has a unique transaction code that is created from a database maintained by the Financial Institution, by the processor or the merchant. The unique transaction code system is also useful for profiling and tracking as the confirmation or validation message containing the unique transaction code has identified positions and fields that are populated with alpha or numeric value options as determined by the stakeholders of the unique transaction code system. The whole transaction is completed in about 3-25 seconds, which constitutes a real time transaction.

The payment transfer may be effected in one or more currencies where the consumer and the merchant so require. Where the payment transfer is to transfer funds from a payer to a payee and the payer transfers the funds in a first currency and the payee receives the funds in a second currency, several steps to accommodate the different currencies are required. The consumer must access his or her online banking service and identify or designate the merchant that will be the payee of the money transfer. The payment amount is specified in the currency desired by the vendor as well as the account to be used for the source of funds. The payment amount is converted into the first currency, that is, the currency that the user account is maintained in at the user's FI. The converted amount is then drawn from the source of funds specified by the user and is transferred to the payment processor's suspense account. The payment processors suspense account is used to make the payment to the merchant in the second currency, that is the currency desired by the merchant in settlement of the transaction.

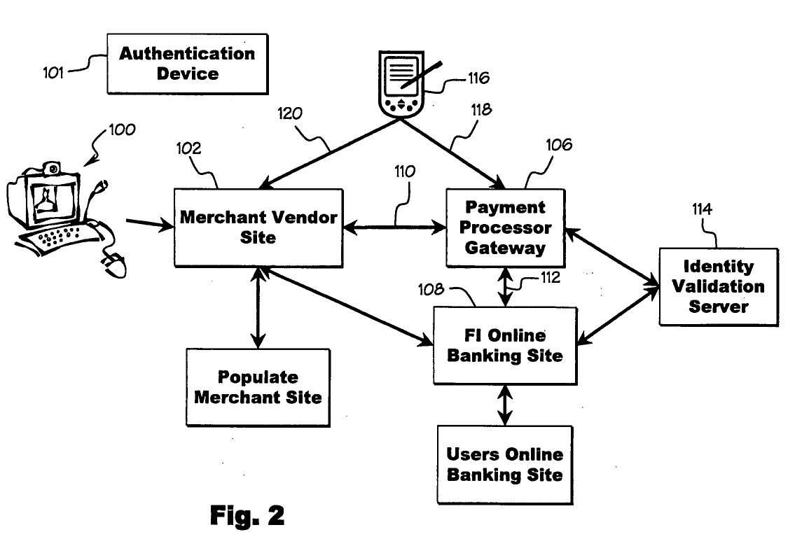

FIG. 2 shows a functional block diagram of an embodiment of the invention showing variations in devices that can be used to implement the invention. A consumer may operate a terminal device 116 which is a mobile device such as a SMS text phone, personal digital assistant (PDA) or pocket personal computer (PPC) to connect to and communicate with the payment processor gateway directly as at 118 or through a merchant web site as at 120 depending on whether the terminal device is hypertext transfer protocol (HTTP) enabled with a web browser or simply a text device that is SMS enabled. In the case of telephone/mobile PDA confirmation, once the payer or consumer has commanded the system to make the payment, an encrypted or non encrypted payment confirmation message and unique transaction code could be sent from the Financial institution servers to the same servers where the confirmation code is sent to the PDA via text messaging, for example using SMS PMS messaging systems or audibly using a text-to-voice translation of the payment confirmation message and unique transaction code.

For payment using an SMS system, the consumer will use a terminal device 116 that is a mobile device to establish communication with the payment processor gateway and authenticate to the gateway. Once authenticated the consumer provides a unique SMS code to identify the merchant that payment is to be directed to as well as the desired source of funds account and amount to be paid thereby completing the required transaction identification information. Payment confirmation including a unique transaction identification code will be provided to the mobile terminal device 116 for the information of the consumer and the merchant vendor. Actual settlement of the transaction with the vendor by the payment processor service may proceed using the settlement options described with reference to FIG. 1.

In another manner of operation, the terminal device 116 provides telephone service and a telephone based audio confirmation path 118 is used which does not require anything more to operate than the telephone audio capabilities of the terminal device 116. The terminal device in this application may be a mobile terminal device or may be a fixed land line POTS or VoIP based telephone device. The payment processor gateway has an interactive voice response system (IVR) which is used to process the consumer payment request. The payment processor gateway can direct and connect the consumer to the telephone banking facilities of their bank or financial institution to complete the payment settlement process. For example, to pay a payee that is not in the consumer's personal payee list, the merchant or vendor name is spoken to the bank telephone banking system and the telephone key pad or audible input is used to provide the source of funds and the account number of the merchant at the payment processor interactive voice response (IVR) site.

The consumer user is then taken through a challenge-response process to authenticate the user. The challenge-response process may ask the user to provide a bank card number and the associated authentication or activation information. The authentication or activation information is typically a personal identification number (PIN) or other password, such as a name or word assigned by and known only to the user, which is used to authenticate the use of the card in making a payment from that FI. In another embodiment, the authentication information is produced by an authentication device 101. In one arrangement the authentication device 101 is a synchronization device that produces temporal authentication information that changes over time. For example an LCD card or keychain fob having a display to produce and display at least a portion of the authentication information. The authentication information produced by the synchronization device can vary with each login or over a fixed time duration such as every few days, minutes or seconds. In another arrangement the authentication device 101 is a biometric scanner that performs a fingerprint, retinal or iris scan to produce authentication information that is unique to each individual that is scanned by the biometric scanner.

In the preferred manner of operation, the authentication or activation information is maintained by the FI and is unknown to the payment processor. In another manner of operation the payment processor authenticates the user and the authentication or activation process is performed by the payment processor and is initiated and completed by the payment processor before forwarding the user, or any information obtained from the user, to the FI site or FI database.

On completion of the authentication and transaction identification step, the settlement commitment for payment of the merchant will be confirmed to the user and/or merchant. The settlement payment would be made from the FI to the payment processor who would then provide a settlement payment to the merchant for security as the payment processor would be qualified to be linked to the bank network. The transaction settlement commitment is uniquely identified by a payment confirmation number and the settlement payment for the transaction refers to the payment confirmation number to facilitate execution and orderly reconciliation of settlement commitments with settlement payments. The payment confirmation number could also be alpha numeric activation code with activation and an expiry or valid-until date for entry to web sites. This code would be created by the bank and validated by the merchant to open or allow access to the settlement payment funds.

In this manner a consumer is able to pay for a service by a telephone call being sent to the consumers FI telephone banking gateway by dialing or by a voice command stating the name of the FI. To use this manner of payment, the consumer will have accepted the FI terms and conditions from the website and entered their home phone line based number or possibly their cell if in the future or providing the cellular company's validate the user online to act as a validation.

To make a payment using the telephone banking process, the consumer will call a predetermined number, for example, did 900, 1010 or toll number or LD to reach a voice prompt which asks you what is the name of your FI or may ask you what for the name or keyword of the company you are going to be paying. In no particular order or have both options or one may be later in the IVR session.

Telephone Banking From a Website or Electronic media Wireless.

Telephone Banking—consumer is instructed in a step 1 to call a number on their phone or from their computer (VoIP). The number they call is assigned to the merchant processor). IVR prompt for “please say your FI. (routing from tables then ID the FI's telephone banking number and route to that). Consumer will now be following existing prompts and following instruction from existing FI IVR to respond by DTMF, VOICE or VoIP signal tunes from pressing number key options.

(Command voice recognition). Consumer asked for username and password or PIN.

In the case where merchant is being represented by a processor or the processor is acting on behalf of payment would be sent to the processor and processor would send it to the merchant in real time, not delayed. The merchant must be registered as a payee or be represented by a processor who is registered as payee.

The payee list would reside in a voice recognition database where the voice to text translation with a text to voice response would come back for further instructions or verification or confirmation. For example, would you like to pay for this please say yes or no thank you please call again). (which account please say your account type now or with a touch tone phone please key in the account number now and press # when finished). (In all possible combinations of order). Once payee is chosen then the consumer would be asked to or for how much please say the amount may ask in what currency or ask to key in amount using a touch tone phone key in may be default if voice recognition does not fulfill request. Consumer is then told to complete transaction/payment please say “pay” aka—keyword now i.e. “buy”.

Key words such as payee would be registered and protected a thank you prompt is heard by consumer. (Or asked a multiple of times to complete the transaction before disconnecting the consumer from the call transaction). A validation is sent to merchant via e-mail or interactive validation or an automated phone call that sends a DTMF tone, which is confirmation of the transaction.

When the user accesses the IVR component of the payment processor gateway, the user is provided with an audio prompt to select the desired FI telephone banking site using the telephone keypad, for example:

Dial 1234—RBC

Dial 2341—Scotia

Dial 1795—BMO

Dial 15678—Chase

Dial xxxx—for stock quotes where a brokerage selection is made, preferably with a default. For example a default to TD Waterhouse if no brokerage is selected from all available brokerage houses.

SMS/PMS

PMS or SMS code—To Voice—telephone debit banking or Data/web online banking Text instructions similar or same as voice but in text instructions and the same prompts as an ATM with service fee acceptance as well.

The telephone/SMS banking purchase may be made from printed media. For example, the printed media may provide the following instructions: “To buy this now call COMPANY X processor” that has assigned number to their customer if the consumer has dialed a “general” number where there are multiple customers they may be asked to say or key in a keyword which sends them to the next prompt where they are asked to say the name of their financial institution. Then goes to Voice command—keyword gateway—where the consumer may be asked to say the keyword now which routes to a prompt to ask for their account number account type i.e. chq/savings.

While the invention has been described above in terms of one or more preferred embodiments, it is not limited thereto but rather is defined in the appended claims. As will be understood by those skilled in the art, various features and aspects of the above described invention may be used individually or jointly. Further, although the invention has been described in the context of its implementation in particular environments and for particular purposes, e.g. in providing payment services, those skilled in the art will recognize that its usefulness is not limited thereto and that the present invention can be beneficially utilized in any number of environments and implementations. Accordingly, the claims set forth below define the full breadth and spirit of the invention as disclosed herein.

What is claimed is:

1. A payment transfer system for transferring funds from a payer to a payee, from an online payment processor gateway accessible from a merchant web site by the payer comprising:
i) means for identifying a payer and designating a payer financial institution;
ii) means for specifying a source of funds and payment amount for a transfer of funds from the payer financial institution;
iii) means to transfer said payment amount from said source of funds to a gateway suspense account;
iv) means for identifying a payee corresponding to the merchant web site;
v) means for payee settlement of the payment amount from the gateway suspense account; and
vi) means to reconcile the gateway suspense account.

2. The payment transfer system of claim 1 wherein said means for identifying the payer includes means for initiating a request to respond to one or more challenge-response questions defined by the payer, and means for processing responses to the challenge-response questions, verifying the accuracy of the responses and effecting a financial transaction only where the responses are verified to be accurate.

3. The payment transfer system of claim 1 wherein said means for identifying the payer includes exchange of messages with an outside identity validation server.

4. The payment transfer system of claim 1 wherein said means for identifying the payer includes authentication information derived from an authentication device.

5. The payment transfer system of claim 4 wherein said authentication device comprises a synchronization device that produces temporal authentication information that changes over time, including varying said authentication information with each login or over a fixed time duration such as every few days, minutes or seconds.

6. The payment transfer system of claim 4 wherein said authentication device comprises a biometric scanner that performs a fingerprint, retinal or iris scan to produce said authentication information that is unique to each individual that is scanned by the biometric scanner.

7. The payment transfer system of claim 1 wherein the means for identifying a payee corresponding to the merchant web site and payment amount includes a message provided to the online payment processor gateway from the merchant web site.

8. The payment transfer system of claim 1 wherein the means for identifying a payee corresponding to the merchant web site and payment amount includes a message provided to the designated payer financial institution from the merchant web site.

9. The payment transfer system of claim 1 wherein the means for identifying a payee corresponding to the merchant web site and payment amount includes a message provided to the designated payer financial institution by the payment processor gateway derived from the merchant web site.

10. A payment transfer method for transferring funds from a payer to a payee, comprising the steps of:
i) providing a payment processor gateway accessible from a merchant web site;
ii) receiving an identification of a payer and a designation of a payer financial institution at the payment processor gateway;
iii) receiving a specification of a source of funds and payment amount for a transfer of funds from the payer financial institution;
iv) producing a settlement commitment;
v) transferring said payment amount from said source of funds to a gateway suspense account;
vi) identifying a payee corresponding to the merchant web site;
vii) providing payee settlement of the payment amount to the identified payee from the gateway suspense account corresponding to said settlement commitment; and
viii) reconciling the gateway suspense account.

11. The method of claim 10 wherein the step of receiving an identification of a payer includes the steps of initiating a request to respond to one or more challenge-response questions defined by the payer, processing responses to the challenge-response questions, verifying the accuracy of the responses and effecting a financial transaction only where the responses are verified to be accurate.

12. The method of claim 10 wherein the step of receiving an identification of a payer includes exchange of messages with an outside identity validation server.

13. The method of claim 10 wherein the step of receiving an identification of a payer includes deriving authentication information from the payer's use of an authentication device.

14. The method of claim 13 wherein said authentication device comprises a synchronization device that produces temporal authentication information that changes over time, including varying said authentication information with each login or over a fixed time duration such as every few days, minutes or seconds.

15. The method of claim 13 wherein said authentication device comprises a biometric scanner that performs a fingerprint, retinal or iris scan to produce said authentication information that is unique to each individual that is scanned by the biometric scanner.

16. The method of claim 10 wherein the steps of identifying a payee corresponding to the merchant web site and payment amount includes providing a message to the online payment processor gateway from the merchant web site.

17. The method of claim 10 wherein the steps of identifying a payee corresponding to the merchant web site and payment amount includes providing a message to the desginated payer financial institution from the merchant web site.

18. The method of claim 10 wherein the steps of identifying a payee corresponding to the merchant web site and payment amount includes providing a message to the desginated payer financial institution by the payment processor gateway derived from the merchant web site.

19. A system for generating a payment request for a recipient, comprising:
i) means for accessing a first online banking service;
ii) means for providing payment request data to the first online banking service including a payment amount and an account for receiving a payment described by the payment request data;
iii) means for notifying the recipient of the payment request;
iv) means for specifying an account affiliated with the recipient to receive the payment amount of the payment request;
v) means for approving receipt of the payment amount of the payment request on the specified account affiliated with the recipient; and
vi) means for effecting a transfer of funds in the amount of the payment amount of the payment request from the first online banking service to the account affiliated with the recipient for receiving the payment.

20. The system of claim 19 wherein said means for accessing a first online banking service includes means for identifying a payer that includes exchange of messages with an outside identity validation server.

21. The system of claim 19 wherein said means for accessing a first online banking service includes means for receiving authentication information identifying a payer that is derived from an authentication device.

22. The system of claim 21 wherein said authentication device comprises a synchronization device that produces temporal authentication information that changes over time, including varying said authentication information with each login or over a fixed time duration such as every few days, minutes or seconds.

23. The system of claim 21 wherein said authentication device comprises a biometric scanner that performs a fingerprint, retinal or iris scan to produce said authentication information that is unique to each individual that is scanned by the biometric scanner.

24. A payment transfer system for transferring funds from a payer to a payee where the payer transfers the funds in a first currency and the payee receives the funds in a second currency comprising:
i) an online payment processor gateway accessible by the payer from a merchant web site including means for identifying the payer and designating a payer source of funds and means for specifying a payment amount in the first currency for a transfer of funds in the first currency from said payer source of funds;
ii) means for receiving said payment amount in the first currency from said payer account and retaining said funds in the first currency in a payment processor suspense account;
iii) means for converting the payment amount in the first currency to a payment amount in said second currency;
iv) means for identifying the payee and specifying a payee account to receive the funds of the payment amount of the second currency;
v) means for debiting the funds in the second currency from the suspense account and crediting the funds in the second currency to the payee account; and
vi) means for reconciling the payment processor suspense account.

25. The payment transfer system of claim 24 wherein said means for identifying the payer comprises means for initiating a request to respond to one or more challenge-response questions defined by the payer, and means for processing responses to the challenge-response questions, verifying the accuracy of the responses and effecting a financial transaction only where the responses are verified to be accurate.

26. The payment transfer system of claim 24 wherein said means for identifying the payer includes exchange of messages with an outside identity validation server.

27. The payment transfer system of claim 24 wherein said means for identifying the payer includes authentication information derived from an authentication device.

28. The payment transfer system of claim 27 wherein said authentication device comprises a synchronization device that produces temporal authentication information that changes over time, including varying said authentication information with each login or over a fixed time duration such as every few days, minutes or seconds.

29. The payment transfer system of claim 27 wherein said authentication device comprises a biometric scanner that performs a fingerprint, retinal or iris scan to produce said authentication information that is unique to each individual that is scanned by the biometric scanner.

30. The payment transfer system of claim 24 wherein the means for identifying a payee and specifying a payee account and payment amount in said second currency includes a message provided to the online payment processor gateway from the merchant web site.

31. The payment transfer system of claim 24 wherein the means for identifying a payee and specifying a payee account and payment amount in said second currency includes a message provided to the designated payer financial institution from the merchant web site.

32. The payment transfer system of claim 24 wherein the means for identifying a payee and specifying a payee account and payment amount in said second currency includes a message provided to the designated payer financial institution by the payment processor gateway derived from the merchant web site.

33. A payment transfer method for transferring funds from a payer to a payee, where the payer transfers the funds in a first currency and the payee receives the funds in a second currency, comprising the steps of:
i) accessing a banking service affiliated with the payer;
ii) designating a payee;
iii) specifying a payment amount in the first currency for a transfer of funds and a payer account from which to draw funds in the first currency;
iv) debiting said funds in the first currency from said payer account and crediting said funds in the first currency into a suspense account;
v) converting the payment amount in the first currency to a payment amount in the second currency;
vi) accessing a second online banking service affiliated with the payee and identifying the payee and a payee account to receive the funds of the payment amount of the second currency; and
vii) debiting the funds in the second currency from the suspense account and crediting the funds in the second currency to the payee account.

34. The method of claim 33 wherein said step of accessing a banking service affiliated with the payer further includes the steps of initiating a request to respond to one or more challenge-response questions defined by the payer, processing responses to the challenge-response questions, verifying the accuracy of the responses and effecting a financial transaction only where the responses are verified to be accurate.

35. The method of claim 33 wherein the step of accessing a banking service affiliated with the payer further includes the steps of receiving an identification of a payer based on an exchange of messages with an outside identity validation server.

36. The method of claim 33 wherein the step of accessing a banking service affiliated with the payer further includes the steps of receiving an identification of the payer based on authentication information derived from the payer's use of an authentication device.

37. The method of claim 36 wherein said authentication device comprises a synchronization device that produces temporal authentication information that changes over time, including varying said authentication information with each login or over a fixed time duration such as every few days, minutes or seconds.

38. The method of claim 36 wherein said authentication device comprises a biometric scanner that performs a fingerprint, retinal or iris scan to produce said authentication information that is unique to each individual that is scanned by the biometric scanner.

39. The method of claim 33 wherein the steps of designating a payee and payment amount in either said first currency or said second currency is provided by the payee.
